(19) United States
(12) Patent Application Publication
(10) Pub. No.: US 2021/0011881 A1
(43) Pub. Date: Jan. 14, 2021

(54) System and method for insertable and removable file system

(71) Applicant: DataJaguar, Inc, Danville, CA (US)

(72) Inventor: Jonathan Zhanjun Yue, Danville, CA (US)

(21) Appl. No.: 16/683,538

(22) Filed: Nov. 14, 2019

Related U.S. Application Data
(60) Provisional application No. 62/921,757, filed on Jul. 8, 2019.

(51) Int. Cl. G06F 16/13; G06F 16/11; G06F 16/182; G06F 16/901

(52) U.S. Cl. CPC G06F 16/134; G06F 16/9017; G06F 16/182; G06F 16/122

(57) ABSTRACT

In embodiments of the present application, data is stored in a complex file which contains a plurality of regular files in a file system. A regular file is any file in a traditional file system. The term “complex file” refers to a sequence of regular files on disk to represent one logical file in whole. A complex file includes all the application interface (API) of a regular file, such as open, read, write, seek, status, close operations. In addition, a complex file has an insert API for inserting a block of data into the file, and removal API for removing a block of data from the file. A complex file can be encapsulated in a directory or any location in a file system. The files inside a complex file are called internal files.

### CROSS REFERENCE TO RELATED APPLICATIONS

This application claims the benefit of provisional application 62/921,757, filed on Jul. 17, 2019, the entirety of which is incorporated by reference.

### BACKGROUND

A computer file system includes the methods and processes to organize files for efficient data storage and retrieval.

Conventional computer file systems such as the ext4 or the XFS append data at the end of a file, or replace data in a region of the file. However, in these conventional systems, data cannot typically be inserted in the middle of a file. Similarly, a block of data typically cannot be removed from a file. However, in many computer applications, it is often desirable to be able to insert a block of data at any position within a file without changing any existing data in the file. Removal of a block of data may also be desired.

### BRIEF DESCRIPTION

The present disclosure describes systems and methods of a file system where a block of data can be inserted or removed at any position of a file. The disclosure introduces a new type of file, the complex file, where data can be inserted anywhere (head, tail, or any position in between) in a complex file, and data can be removed from any position in a complex file.

In embodiments of the present application, data is stored in a complex file which contains a plurality of regular files in a file system. A regular file is any file in a traditional file system. The term “complex file” refers to a sequence of regular files on disk to represent one logical file in whole. A complex file includes all the application interface (API) of a regular file, such as open, read, write, seek, status, close operations. In addition, a complex file has an insert API for inserting a block of data into the file, and removal API for removing a block of data from the file. A complex file can be encapsulated in a directory or any location in a file system. The files inside a complex file are called internal files.

A complex file can be viewed as a container for regular files. The term “disk” means HDD, SSD, or any type of permanent storage medium. The term “file offset” means the position within a file that is ready for data read and write. In a file system, the offset of a file is usually managed by the operating system and can be changed to any position with a seek operation. The term “local offset” means file offset from the perspective of a regular file inside a complex file. The term “global offset” means file offset from the perspective of the complex file.

In other words, a local offset is measured from the beginning of any internal regular file. A global offset is measured from the beginning of the complex file which is essentially the beginning of the first internal regular file. In an embodiment of the present disclosure, the sequence of internal files is kept in order in the system. Global offsets and local offsets are converted and managed with a control module. When a data operation at a global offset is conducted, a local offset is found in an internal file and the data operation is carried in the internal file. If necessary, one or a plurality of internal files may be updated or replaced if large blocks of data are to be inserted in a complex file.

### BRIEF DESCRIPTION OF THE FIGURES

FIG. 1 depicts a control module that contains lookup tables in a complex file.

FIG. 2 depicts another embodiment of managing regular files in a complex file by ordering of file names.

### DETAILED DESCRIPTION

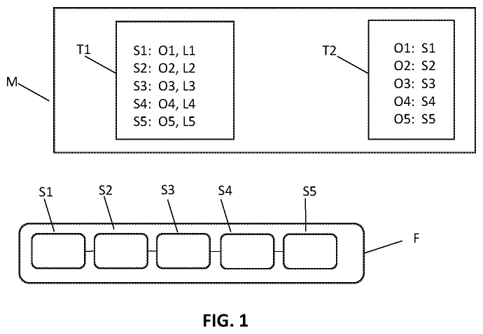

FIG. 1 depicts a complex file F and a control module M that contains lookup tables T1 and T2 for file names, global offsets, file lengths, and any other metadata information. The global offset of an internal regular file within a complex file is the starting position of the internal file measured in the global scope of the complex file. The starting position indicates the position of its first byte in the internal file relative to the beginning of the complex file. In other words, the global offset of an internal file is the total data size of all the internal files preceding the internal file. The data size can be measured by the total number of bytes. The length of an internal file is the data size of the file. In lookup table T1, S1 denotes an internal file, with O1 denoting the global offset of the file, L1 denoting the length of file S1. S2 denotes another internal file, with O2 denoting the global offset of the file, L2 denoting the length of file S2, and so on and so forth for other internal files (S3, S4, and S5). Tables T1 and T2 may contain information for any number of internal files. In table T2, the global offsets are arranged in sorted order, that is, O1 is less than O2, which is less than O3, and so on and so forth. Other meta-data of a file may also be stored in the control module M.

Given an internal file name, the offset and length of the file can be quickly retrieved from table T1. Given a global offset, the internal file that contains the offset is retrieved from table T2. The table T1 may be organized as the Binary Search Tree, B-Tree, hash table or any other structure for quickly finding strings. Table T2 may be organized as the Binary Search Tree or the B-Tree, or any other structure for managing ordered data. If an offset is not found in table T2, then the predecessor of the offset is found and used. For example, if an offset O is between O3 and O4, then O3 is found and used by looking up the table T2. Offset O3 is the predecessor of O in table T2.

The global offset is important because it helps to find an internal file to conduct data reads and data writes. If the system is to read or write data at any offset O in a complex file, then the system first finds the offset or the predecessor of the offset from table T2. The internal file corresponding to the offset or its predecessor is then found and used. If we use P to denote the offset of the found internal file, denoted by G, then the read or write operation starts at location O−P (subtracting P from O) within the internal file G.

The internal files S1, S2, S3, S4, and S5 are for illustration purpose only. There can be any number of internal files in a complex file. The internal files are organized in an ordered list. The order is determined by the global offsets of the internal files. By looking up table T2, the internal file that is responsible for an offset is found, and consequentially, file length is found in table T1. The end position of a complex file is the end position of the last internal file inside the complex. So appending data to a complex file is achieved by appending data to the last internal file in the complex file.

Given a position G of a complex file where a block of data of size C is to be read, the system finds the internal file I corresponding to the offset G, then performs a read operation at position G−F (G subtracting F), where F is the global offset of the internal file I. To perform a write operation at position G of a complex file, a write operation is done at position G−F of the corresponding internal file. Data read and write operations are translated into local read and write operations performed on a corresponding internal file.

Given a position G of a complex file where a block of data of size C is to be inserted, the system finds the internal file I corresponding to the offset G, then performs a combination operation at position G−F (G subtracting F), where F is the global offset of the internal file I. The combination operation first reads data from the beginning of file I to the position immediately prior to G−F. The read data is written to a new file N. Then the data block of size C is appended to the file N. Next, data is read from position G−F in file I and the read data is written to file N. Finally, the original file I is replaced by the new file N. All the global offsets and file lengths in the control module are updated to the correct numbers. If the position G−F falls at the end of internal file I, then the data block of size C is appended directly to the file I which is not replaced by any new file. The control module is always updated upon inserting a new block of data.

Given a position G of a complex file where a block of data of size C is to be removed, the system finds the internal file I corresponding to the offset G, then performs a disposal operation at position G−F (G subtracting F), where F is the global offset of the internal file I. The disposal operation first reads data from the beginning of file I to the position immediately prior to G−F. The read data is written to a new file N. Then the data block of size C is skipped and ignored in file I. Next, data is read from position G−F in file I and the read data is written to file N. Finally, the original file I is replaced by the new file N. All the global offsets and file lengths in the control module are updated to the correct numbers. If size C of the data block to be removed is equal to the file size of file I, then file I is directly dropped from the complex file. The control module is always updated upon removing a block of data.

The data entries in the control module may be maintained in both the main memory and on disk. If it is managed on disk, then changes in main memory are synchronized to the disk immediately or periodically. In case of power failure, system crash, or other scenarios where a system restart is needed, the system reads the control module from the disk and builds the control module in main memory.

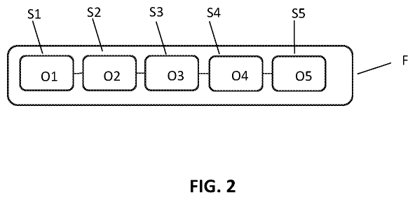

FIG. 2 illustrates a second embodiment of initializing the control module during system restart. A restart is needed if the system suffers from power failure, device failure, or any other disasters. The initialization depends on the names of the internal files only instead of a separate disk file for the control module. This embodiment requires the system follow a naming convention when it creates a new internal file in a complex file. In a complex file F, the name of an internal file contains the global offset of the file. The global offset may be the only component in the file name. The offset may be part of the file name. When comparing the order of file names, we use the numerical value of the offset in the file name for the numerical comparison. In FIG. 2, file S1 has the name “O1”, the global offset of the file. File S2 has the name “O2”, the global offset of the file, and so on and so forth. When the offset of an internal file Sᵢ (i is the i-th internal file) is changed either because of inserting or removing block of records, then the name and offset of files Sⱼ (j>i) will also be updated to reflect the changes. The offset is increased by the same amount of data that is inserted. The control module M in FIG. 1 may also need to be updated.

With this naming convention, no separate file storage for the control module is needed. During restart of the system, the regular file names belonging to a complex file are read and are sorted according to the order. The regular file names may be marked with different notations for different complex files. In modern file systems, file size can be retrieved from the file system for a given file. Therefore, the control module can be built by just scanning the directory that contains the internal files and ordering the names of the internal files.

1. A method of storing file system data, comprising:
receiving, at a processor, a request to insert data;
providing a control module that contains a plurality of lookup tables in a complex file with a global scope, wherein each complex file is comprised of a plurality of internal files, and wherein a global offset of each internal file within the complex file is the starting position of the internal file measured in the global scope of the complex file;
retrieving a specific offset from a lookup table T2 in the plurality of lookup tables, and if an offset is not found in table T2, then using a predecessor of the offset;
finding an internal file based on the specific offset;
starting the insert operation at a location formed by subtracting the specific offset from the global offset.

2. The method of claim 1, wherein the internal files are organized in an ordered list.

3. The method of claim 2, wherein the order is determined by the global offsets of the internal file.

4. The method of claim 3, wherein by looking up table T2, the internal file that is responsible for an offset is found, and consequentially, file length is found in table T1.

5. The method of claim 1, wherein the data entries in the control module are maintained in main memory.

6. The method of claim 1, wherein data entries in the control module may be maintained on disk.

7. The method of claim 6, further comprises restarting the system by reading the control module from the disk and building the control module in main memory
